(19) United States
(12) Patent Application Publication
(10) Pub. No.: US 2007/0286351 A1
(43) Pub. Date: Dec. 13, 2007

(54) Method and System for Adaptive Media Quality Monitoring

(75) Inventors: Randall P.J. Ethier, Burke, VA (US); Rajesh Kumar, Palo Alto, CA (US); Robert J. Biskner, Santa Barbara, CA (US); Chelliah Sivachelvan, Carrollton, TX (US); Mohamed S. Mostafa, Emerald Hills, CA (US); Scott S. Firestone, Mountain View, CA (US); Michael A. Ramalho, Sarasota, FL (US); Kevin J. Connor, Blaine, WA (US); James C. Frauenthal, Colts Neck, NJ (US); Michael P. Hammer, Reston, VA (US)

Correspondence Address: Baker Botts;Bart Showalter, 2001 Ross Avenue, Suite 600, Dallas, TX, 75201, US

(73) Assignee: Cisco Technology, Inc.

(21) Appl. No.: 11/419,913

(22) Filed: May 23, 2006

(51) Int. Cl. H04M 3/08; H04M 3/22; H04M 1/24

(52) U.S. Cl. 379/32.01

(57) ABSTRACT

A method for adaptive media quality monitoring includes monitoring at least one metric of a call between at least two endpoints and detecting a threshold crossing event via the monitoring of the at least one metric. The method also includes executing a threshold crossing action based on detecting the threshold crossing event. The threshold crossing action comprises monitoring at least one additional metric of the call.

### TECHNICAL FIELD OF THE INVENTION

This invention relates generally to communications systems and, more particularly, to a method and system for adaptive media quality monitoring.

### BACKGROUND

As the internet and internet protocol (IP) based applications such as packet voice and video continue to grow in popularity and pervasiveness so do the products and services that are associated therewith. The large number of internet users spread throughout the world and the wide variety of hardware components and software used therein presents numerous opportunities for the media streams to become impaired. Such impairments may include latency, low signal level, picture distortion, high noise level, gaps in real-time telemetry or low mean opinion score. The impairments may, for example, be caused by packet loss between the two endpoints, excessive traffic at any of the components between the two endpoints, loss of synchronization between a plurality of media streams arriving at any endpoint, or incompatible hardware or software between the two endpoints or other components. The possibility of media degradation has caused some users to be hesitant about switching from traditional products or services to products or services that use internet protocol (IP).

To help ensure the quality of the products and services enabled by the internet, some products and services include diagnostic capabilities that may report the quality of the service. The content of the report is usually predetermined before the service is invoked and is usually sent at a predetermined time. It requires a certain amount of network or endpoint resources to generate, transmit and store these reports. Furthermore, including every possible report for the entire duration of every call is computationally expensive and can create an unusable overload of information. To help alleviate some of the strain on network resources when there may be network failures, some devices and service provide for a minimum spacing between reports.

### SUMMARY

In accordance with the present invention, a method and system for adaptive media quality monitoring is provided which substantially eliminates or reduces the disadvantages and problems associated with previous systems and methods.

In accordance with a particular embodiment of the present invention, a method for adaptive media quality monitoring includes monitoring at least one metric of a call between at least two endpoints and detecting a threshold crossing event via the monitoring of the at least one metric. The method also includes executing a threshold crossing action based on detecting the threshold crossing event. The threshold crossing action comprises monitoring at least one additional metric of the call.

The threshold crossing action may further include: (1) generating a metric report upon detecting a threshold crossing event through the monitoring of the at least one metric, (2) initiating at least one consequent action from the group consisting of initiating a trace route, re-routing the call, changing a codec type, changing a frame size, and changing a packetization period, (3) generating periodic reports of the monitored at least one metric during the call, (4) generating periodic reports of the monitored at least one additional metric during the call, (5) monitoring the at least one additional metric of the call for a predetermined amount of time during the call and/or (6) monitoring at least one additional metric for subsequent calls for a predetermined amount of time.

Where the method includes monitoring at least one metric of a call, the method may include monitoring a plurality of metrics of the call. Where the method includes detecting a threshold crossing event via the monitoring of the at least one metric the method may include evaluating the plurality of metrics and detecting a threshold crossing event based on the evaluation of the plurality of metrics.

Where the method includes monitoring at least one metric of a call between at least two endpoints the method may include monitoring at least one metric of the call at one of the at least two endpoints and/or monitoring at least one metric of the call at an intermediary component between the at least two endpoints. In some embodiments the intermediary component may be an edgepoint.

The at least one metric may comprise at least one metric selected from the group consisting of packet loss metric, blockiness metric, delay metric, blurriness metric, jerkiness metric, jitter metric, echo metric, signal level metric, frame freeze event metric, frame skip event metric, temporal complexity metric, spatial complexity metric, noise level metric, mean opinion score metric, concealed seconds metric, and severely concealed seconds metric.

In accordance with another embodiment of the present invention, a system for adaptive media quality monitoring includes an interface operable to monitor at least one metric of a call between at least two endpoints. The system includes a processor coupled to the interface and operable to detect a threshold crossing event via the interface operable to monitor the at least one metric. The processor is also operable to execute a threshold crossing action based on detecting the threshold crossing event. The threshold crossing action comprises monitoring at least one additional metric of the call.

Technical advantages of particular embodiments of the present invention include media quality monitoring that adapts to detected impairments in the quality of the media to provide more specific diagnostic information. The media devices may modify how they transmit their media, and media service providers may use the information in making changes in how they provide the media service. Accordingly, the quality and/or efficiency of the communication network may be optimized. Another technical advantage includes sending diagnostic information if and when a media impairment is encountered. Accordingly, the defect may be corrected before the call terminates. Additionally, the amount of diagnostic information generated can reflect the severity and type of the impairment detected, as opposed to generating the same diagnostic information regardless of the type, severity or existence of an impairment.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates a communication system including a plurality of endpoints operable to communicate among each other using internet protocol, in accordance with a particular embodiment of the present invention;

FIG. 2 illustrates a media quality monitoring system, illustrating aspects of the present invention; and

FIG. 3 illustrates a method for adaptive media quality monitoring, in accordance with an embodiment of the present invention.

### DESCRIPTION OF EXAMPLE EMBODIMENTS

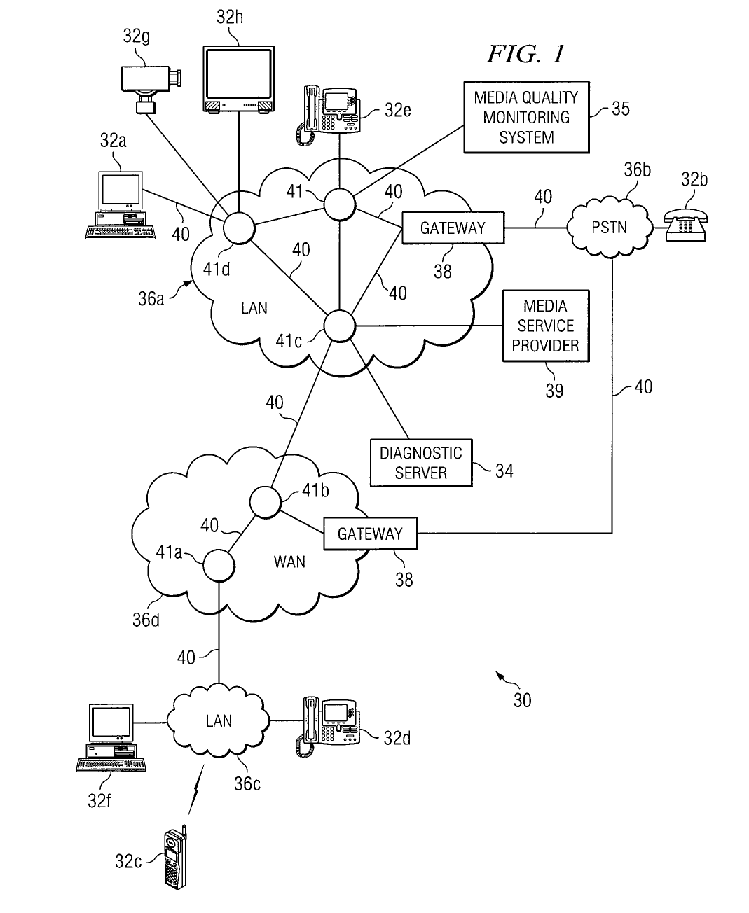

FIG. 1 illustrates a communication system 30 including a plurality of endpoints 32a-32h having the ability to communicate with each other using one or more of communication networks 36a-36d. Communication system 30 also includes media quality monitoring system (MQMS) 35, media service provider (MSP) 39 and/or diagnostic server 34. Endpoints 32a-32f and MQMS 35 may also have the ability to communicate diagnostic information between each other, MSP 39 and/or diagnostic server 34. The diagnostic information may include metric reports containing information concerning various aspects of the media stream as measured by various metrics. The reports may be useful for such things as service level agreements, fault detection and trouble shooting. MSP 39 may provide a service being used by an endpoint. For example, MSP 39 may facilitate voice over internet protocol (VoIP), video over IP, or on-line gaming. Diagnostic server 34 provides a device for storing and/or indexing diagnostic logs of the diagnostic information sent by, for example endpoints 32 or MQMS 35.

Calls may include the sending or receiving of media transmitted using any audio, video or other data means, including signals, data or messages transmitted through any suitable technology, such as voice communications, text chat, web sessions, facsimile, on-line gaming, instant messaging and e-mail.

Throughout communication system 30 devices, such as endpoints 32, nodes 41, MQMS 35 and/or MSP 39, may monitor the media quality of calls conducted via communication network 36a. The calls may be monitored via metrics that may be used to monitor, record, compare, rate or otherwise analyze a specific feature(s) of a call. The monitoring may be done at the receiving end, the sending end or anywhere in between (e.g., at an edgepoint). If the quality of the monitored call exceeds or falls below a predetermined threshold various threshold crossing actions may be invoked. The threshold crossing action may include increasing the detail or extent of the monitoring and/or initiating a remedial and/or diagnostic action.

In particular embodiments, one or more metrics may be used in monitoring a call. Each metric may generally be classified as an always reported metric, an unreported metric or a detailed metric. The always reported metric may be reported at the end of each call, at some point during the call or periodically throughout the call. The detailed metric may be reported when certain conditions are met, for example, if a particular impairment is detected. The unreported metric may not directly be used to generate a metric report, but it may be used to trigger any of a number of impairment responses, such as causing a different metric to generate its metric report or initiating any other diagnostic or remedial action that may be desired. Similarly, any of the other metrics may also be used to trigger impairment responses. As alluded to above, any of the metrics may monitor any of a number of particular characteristics of a call. For example, a mean opinion score (MOS) metric may be used to monitor the voice quality of a VoIP call.

In the illustrated embodiment, communication network 36a is a local area network (LAN) that enables calls between a plurality of endpoints 32a-32h and communications (e.g., signaling) between endpoints 32, diagnostic server 34, MQMS 35 and/or MSP 39. The LAN can be distributed across multiple cities and geographic regions and may be referred to as a metro LAN or a wide area network (WAN). Communication network 36b is a public switched telephone network (PSTN) and couples endpoint 32b with communication networks 36a and 36d through gateways 38. Communication network 36c is another LAN, which couples endpoints 32c, 32d, and 32f with communication network 36a. Communication network 36d, an IP WAN, connects LANs 36a and 36c and LAN 36c and PSTN 36b. Accordingly, users of endpoints 32a-32h may establish calls between and among each network component coupled for communication with one or more of networks 36a-36d.

In the illustrated embodiment, communication system 30 includes MSP 39 that facilitates calls among users. For example, MSP 39 may provide a VoIP service or may allow, for example, endpoint 32a to watch video stored on endpoint 32f. MSP 39 may also provide for on-line gaming between two endpoints or any other functionality typically provided by MSPs in communication systems.

MQMS 35, in particular embodiments, may be functionally located between endpoints such that it may monitor the quality of calls between the endpoints. MQMS 35 may monitor the call quality of a call between the same type of endpoints, such as between PCs 32a and 32f running VoIP software, or between different types of endpoints, such as IP phone 32e and PSTN phone 32b. MQMS 35 may be a standalone device, it may be located close to an endpoint or it may be incorporated within any of a variety of different components, such as an endpoint, edgepoint, router or session border controller, within a communication network, at the edge of a domain, or at a midpoint. Regardless of where MQMS 35 is physically located, it may still be capable of detecting, analyzing and/or calculating media quality metrics and generating and/or receiving metric reports detailing specific qualities of a call. Generating a metric report may include collecting and processing data from a specific metric to create a summary of call characteristics associated with the metric and sending the report to another device. These metric reports may, for example, be used by MSP 39 in determining billing rates for its customers as per a service level agreement (SLA).

Communication system 30, in the illustrated embodiment, also includes diagnostic server 34 that maintains a log(s) of diagnostic information, such as the various metric reports sent or received by MQMS 35. The log may be used, for example, by a service technician from MSP 39 to view the media quality history of a particular endpoint to aid in diagnosing that endpoint or of communication network 30 to help troubleshoot a possible network failure.

Communication network 36a includes a plurality of segments 40 and nodes 41 that couple endpoints 32a, 32e, 32g and 32h with gateway 38 and communication networks 36b-36d. Therefore, a user of endpoint 32a is provided with access to endpoints 32b-32h. Furthermore, endpoints 32a-32h, diagnostic server 34, MQMS 35 and MSP 39 may all communicate control and data signals among each other. Nodes 41 may include any combination of network components, session border controllers, gatekeepers, call managers, conference bridges, routers, hubs, switches, gateways, edgepoints, endpoints, or other hardware, software, or embedded logic implementing any number of communication protocols that allow for the exchange of packets in communication system 30.

Communication network 36d is an IP WAN and includes nodes 41 and segment 40, similar to LAN 36a. For simplicity, the full scope of a typical IP WAN (e.g., the internet) is not shown. The two nodes depicted may be located at the edge of the communication network 36d (i.e. near the border between communication network 36d and 36a, and between 36d and 36c respectively). Nodes 41 may use various metrics to monitor communications from a call entering IP WAN 36d from the sending endpoint (e.g., endpoint 32c) and communications that have traversed through IP WAN 36d. This may facilitate assessing the effect of IP WAN 36d on call quality as the communications travel through a service provider's domain (as discussed further below).

Communication system 30 may also include a plurality of edgepoints. An edgepoint may be a real-time transport protocol (RTP) media relay point or termination point that may be incorporated within one or more of the devices or components depicted in FIG. 1. For example, if nodes 41 were IP to IP gateways, then any of nodes 41 may include an edgepoint. An edgepoint may also be included in any other network component or device that may, in effect, define a boundary for a particular network, such as gateway 38 of network 36a. Some other possible devices that may incorporate an edgepoint include a session border controller and a policy execution point. The use of an edgepoint may aid a network administrator in ascertaining the contribution of his network to any impairments a call may experience. If the edgepoint is used as a RTP relay point then the media simply passes through the edgepoint. If the edgepoint is used as a RTP termination point then the incoming media stream containing the communication is terminated at the edgepoint and a new media stream is created to send out the communication. This allows for more detailed monitoring of the call quality, but consumes a larger amount of media processing resources.

For example, in a call between endpoint 32f and endpoint 32g, packets of the media stream may pass from endpoint 32f to 41a, then to 41b, then to 41c, then to 41d and finally to endpoint 32g. In this call, the media stream may have passed through four different edgepoints, 41a-41d. Each edgepoint may be located at or near the border of its respective network. Thus, the edgepoint may be the last network component, within a particular network, that the media stream passes through before leaving that network and entering a different network. Each edgepoint 41 may calculate a metric for the media from the edgepoint back to the sending endpoint. For example, for a communication sent from endpoint 32f, edgepoint 41b may calculate a metric that measures media quality from endpoint 32f to edgepoint 41b; and for a communication sent from endpoint 32g, edgepoint 41b may calculate a metric that measures media quality from endpoint 32g to edgepoint 41b.

Metric reports from certain edgepoints may be sent to a MQMS, for example MQMS 35, where they may be used in determining the extent to which a particular network or network domain causes degradation in media quality. More specifically, MQMS 35 may use the difference in media quality between a metric report from edgepoint 41d and a metric report from edgepoint 41c to determine the extent that LAN 36a degraded the quality of a media stream passing through LAN 36a. MQMS 35 may also receive metric reports from edgepoints of different networks. Thus, by using the metric reports of various edgepoints, not only is it possible to determine the end-to-end media quality but it is also possible to assess the network-to-network degradation in media quality.

Although the illustrated embodiment includes four communication networks 36a-36d, the term “communication network” should be interpreted as generally defining any network capable of transmitting audio and/or video telecommunication signals, data, and/or messages, including signals, data or messages transmitted through text chat, instant messaging and e-mail. Any one of networks 36a-36d may be implemented as a local area network (LAN), wide area network (WAN), global distributed network such as the Internet, Intranet, Extranet, or any other form of wireless or wireline communication network. In addition, communication networks in accordance with various embodiments may include any number of MSPs 39, MQMSs 35, or diagnostic servers 34. Generally, networks 36a, 36c and 36d provide for the communication of packets, cells, frames, or other portions of information (generally referred to as packets herein) between endpoints 32a-32h, diagnostic server 34, MQMS 35 and MSP 39 as part of media quality monitoring. Communication networks 36a and 36d may include any number and combination of segments 40, nodes 41, endpoints 32a-32g, MSPs 39 or diagnostic servers 34.

In a particular embodiment, communication network 36a employs voice and/or video communication protocols that allow for the addressing or identification of endpoints, nodes, and/or MQMSs coupled to communication network 36a. For example, using Internet protocol (IP), each of the components coupled together by communication network 36a in communication system 30 may be identified in information directed using IP addresses. In this manner, network 36a may support any form and/or combination of point-to-point, multicast, unicast, or other techniques for exchanging media packets among components in communication system 30. Any network components capable of exchanging audio, video, or other data using frames or packets are included within the scope of the present invention.

Network 36a may be directly coupled to other IP networks including, but not limited to, another LAN or the Internet. Since IP networks share a common method of transmitting data, telecommunication signals may be transmitted between telephony devices located on different, but interconnected, IP networks. In addition to being coupled to other IP networks, communication network 36a may also be coupled to non-IP telecommunication networks through the use of interfaces or components, for example gateway 38. In the illustrated embodiment, communication network 36a is coupled with PSTN 36b through gateway 38. PSTN 36b includes switching stations, central offices, mobile telephone switching offices, pager switching offices, remote terminals, and other related telecommunications equipment that are located throughout the world. IP networks (e.g., networks 36a, 36c and 36d) transmit data (including voice and video data) by placing the data in packets and sending each packet individually to the selected destination, along one or more communication paths. Unlike a circuit-switched network (e.g., PSTN 36b), a dedicated circuit is not required for the duration of a call or fax transmission over IP networks.

Technology that allows telecommunications to be transmitted over an IP network may comprise Voice over IP (VoIP), or simply Voice over Packet (VoP). In the illustrated embodiment, endpoints 32a and 32c-32f, diagnostic server 34, MQMS 35, MSP 39, and gateway 38 may include IP telephony capabilities allowing them to participate in and/or monitor audio, video, and other multimedia communication sessions. IP telephony devices have the ability to encapsulate a user's voice (or other input) into IP packets so that the voice can be transmitted over network 36a. IP telephony devices may include telephones, fax machines, computers running telephony software, nodes, edgepoints, gateways, wired or wireless devices, hand held PDAs, or any other device capable of performing telephony functions over an IP network.

Endpoint 32g may be a video camera capable of capturing video to be encapsulated, similar to voice, into IP packets and transmitted over, for example, communications network 36a. Endpoint 32h may be a monitor capable of receiving IP packets containing video and displaying them. Endpoints 32g and 32h may be part of a single endpoint, for example a video conference system, or they may be separate, for example a remote security camera and video surveillance monitor.

In particular embodiments, communication system 30 may receive and transmit data in a session initiation protocol (SIP) environment. SIP is an application-layer control protocol that includes primitives for establishing, modifying and terminating communication sessions. SIP works independently of underlying transport protocols and without dependency on the type of session that is being established. SIP also transparently supports name mapping and redirection services, which support personal mobility.

It will be recognized by those of ordinary skill in the art that endpoints 32a-32h, diagnostic server 34, MQMS 35, MSP 39 and/or gateway 38 may be any combination of hardware, software, and/or encoded logic that provides communication services to a user. For example, endpoints 32a-32h may include a telephone, a computer running telephony software, a video monitor, a camera, an IP phone, a cell phone or any other communication hardware, software and/or encoded logic that supports the communication of packets of media (or frames) using communication network 36a. Endpoints 32a-32h may also include unattended or automated systems, gateways, other intermediate components or other devices that can establish calls. Although FIG. 1 illustrates a particular number and configuration of endpoints, segments, nodes, and gateways, communication system 30 contemplates any number or arrangement of such components for communicating media. In addition, elements of communication system 30, such as MQMS 35, may include components centrally located (local) with respect to one another or distributed throughout communication system 30.

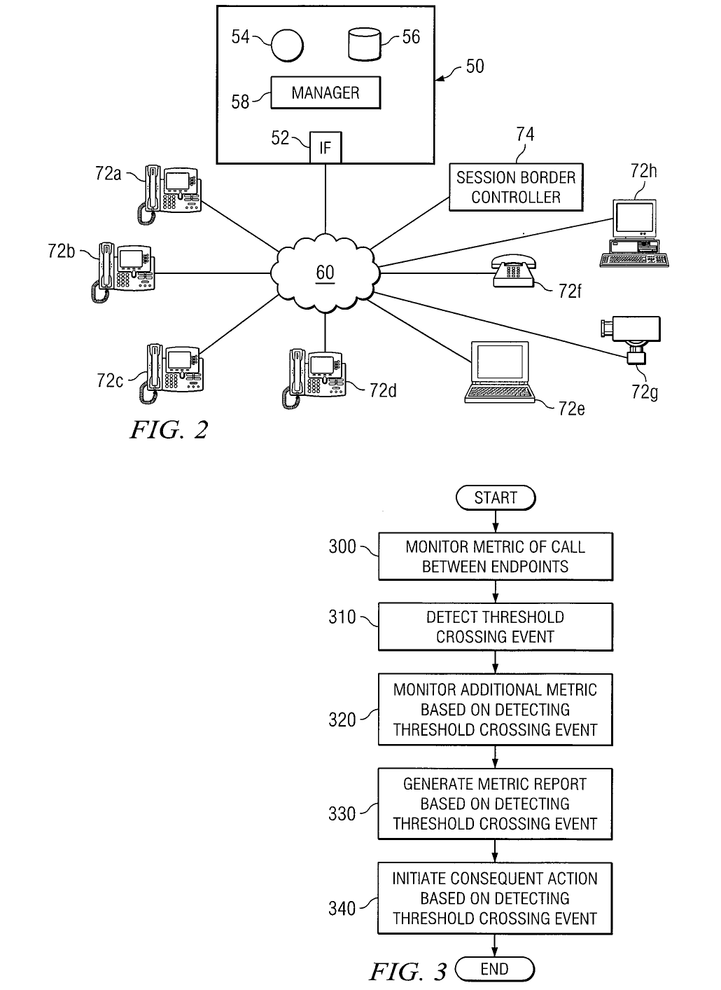

FIG. 2 illustrates a media quality monitoring system, illustrating aspects of the present invention. While media quality monitoring system (MQMS) 50 is depicted as a component separate from endpoints 72a-72h, it should be noted that in particular embodiments the functionality described with respect to MQMS 50 may be incorporated within one or more of endpoints 72a-72h or it may be a component of a larger system, such as an edgepoint, a sniffer near an endpoint, or a session border controller. In the illustrated embodiment, MQMS 50 includes interface 52, processor 54, memory module 56, and manager 58.

Interface 52 couples MQMS 50 with communication network 60 and is operable to send and receive communications, including metric reports, to and from endpoints 72a-72h via network 60. Processor 54 may be a microprocessor, controller, or any other suitable computing device, resource, or combination of hardware, software and/or encoded logic. Processor 54 may perform analysis of the quality of the media of a call and execute various responses according to the quality of the call as described herein with respect to particular embodiments. Memory module 56 may be any form of volatile or non-volatile memory including, without limitation, magnetic media, optical media, random access memory (RAM), read-only memory (ROM), removable media, or any other suitable local or remote memory component. Memory module 56 may store any suitable information to implement features of various embodiments, such as the parameters of particular media metrics.

Manager 58 may maintain a listing, table, database or any other desired organization of information about endpoints 72 and calls facilitated by communication network 60 and any metrics associated therewith. More specifically, the information may include which metrics are currently active for a particular endpoint or call, which endpoints have recently experienced a threshold crossing event, where various metric reports are being sent and what is being done with the metric reports. Manager 58 may comprise any combination of hardware, software, and/or encoded logic.

Endpoints 72a-72h may be similar to one or more of the endpoints 32 described above with respect to FIG. 1. More specifically, depicted in FIG. 2 are IP phones 72a-72d, PCs 72e and 72h, telephone 72f, and camera 72g. PCs 72e and 72h may be personal computers running telephony software enabling them to communicate using, for example, VoIP technology; telephone 72f may be a typical PSTN phone; and camera 72g may be a video camera capable of transmitting video over an IP network, for example, a webcam using Video over IP. As mentioned above, adapting the media quality monitoring as described herein may be performed by an endpoint capable of monitoring the media quality such as IP phones 72a-72d and PCs 72e and 72h as well as by other components within network 60.

Session border controller 74 may functionally be located between communication network 60 and other communication networks. Session border controller 74 may comprise an edgepoint that may aid a network administrator in ascertaining the contribution of his network to any impairments a call may experience. Because the session border controller may house an edgepoint it may monitor communications coming into and leaving communication network 60. The quality of the two flows of communications may be used to help determine where the cause of the impairment is located (within communication network 60 or without).

As indicated above, particular embodiments provide for adapting the extent that the quality of a call may be monitored and/or reported as well as providing functionality for correcting detected impairments in the call. One way that the quality of a call is monitored is through the use of metrics. Metrics may be used in monitoring any of a number of different aspects of a call, such as the media quality of the call (e.g., the blockiness, jerkiness or blurriness of the call), the amount and/or frequency of packet loss during the call, the signal level and/or noise level of the call or any other aspect of the call that may be deemed important. The metric may also be used in generating metric reports which may be sent at the end of a call, at some point during the call, or periodically throughout the call. Any of the metrics may activate other metrics, such as a detailed metric. It should be noted that it is not intended that the present invention be limited in any way to only the use of those metrics set forth herein, rather the present invention contemplates the use of any suitable metric.

It should be recognized that having MQMS 50 generate a large number of metric reports for each call may increase the level of detail of the information concerning a call, but it may do so at the expense of network and/or endpoint resources. The increased number of metric calculations and associated metric reports may require a proportionate increase in the number of resources needed to perform the metric calculations and to generate, transmit and store the increased number of metric reports. This could cause scalability problems for the network, the endpoint or both; and may yield large amounts of unwanted or unusable information. The cost-to-benefit ratio associated with a large number of metrics may skew towards the cost side with each metric report generated. This skewing toward cost is further intensified when the metric report being generated is reporting unneeded information (e.g., constantly reporting that call quality is acceptable). It may be that the number of metric reports containing unneeded information may create impairments for the calls they are monitoring by placing additional strain on network resources.

In particular embodiments of the present invention MQMS 50 may monitor several metrics but may not always generate a metric report for each metric for each call. The metrics used for metric reports that are sent for each call may generally be categorized as always reported metrics, the metrics used for metric reports generated only under certain circumstances may generally be categorized as detailed metrics and the metrics that are not used to generate any metric reports may generally be categorized as unreported metrics. Thus, for example, an endpoint that is sending a metric report at the end of a call may send a metric report based on the always reported metrics and those detailed metrics that were activated during the course of the call, but not based on those detailed metrics that were not activated or any of the unreported metrics. Though the activated unreported metrics and some (or all depending on the circumstances) of the detailed metrics may not be included in a metric report, they may still be used to trigger consequent actions should a threshold crossing event be detected.

The different categories of metrics allow MQMS 50 to monitor several different aspects of a call without having to utilize network resources to generate, send or store metric reports that may not contain desired or useful information. For example, if a MSP knows that most calls have a signal level above a certain level the MSP may not want or need, a metric report generated for each call that reports that the signal level for the call was above the threshold. The MSP, may however, want a metric report should the signal level fall below the threshold. Accordingly, a signal level detailed metric may be used to monitor the signal level of the call. Because the signal level metric report may only be generated when the metric detects a threshold crossing event (e.g., when the signal level falls below the threshold) it may be classified as a detailed metric. Thus, in some embodiments only needed or useful metric reports may be generated.

A threshold crossing event may indicate that there is some impairment with the monitored call. The threshold crossing event may further indicate whether the impairment was caused by a particular endpoint or by some other component within communication network 60. The MQMS 50 may respond to the impairment by initiating any of several threshold crossing actions to generate greater detail concerning the impairment, attempt to remedy the impairment and/or monitor other calls to determine whether it was an isolated event or a more widespread system problem.

For example, assume that endpoints 72b and 72f are involved in a call. Further assume that MQMS 50, using some combination of manager 58, processor 54 and memory 56, has detected a threshold crossing event based on the signal level of the call between endpoints 72b and 72f being below a particular threshold. The threshold crossing event may trigger, for example: (1) generating a metric report based on a signal level metric that may be sent during the call (once or periodically throughout the call) and/or after the call ends, (2) monitoring/activating other metrics, such as other detailed metrics or unreported metrics, (3) initiating a consequent action to correct the problem associated with the low signal level threshold crossing event, (4) changing the timing of when other, particular metric reports are generated (once, or periodically through the call) or (5) initiating a consequent action to attempt to isolate the cause of the low signal level.

A threshold crossing event may comprise any suitable parameter or condition for a given metric. For example, for a MOS metric, a threshold crossing event may comprise a MOS score below a particular level. Furthermore, the threshold crossing event may be based on more than one metric. Manager 58 may combine two or more metrics using such logic operators as ‘and’ or ‘or’ to form the conditions for a particular threshold crossing event. For example, a particular threshold crossing event may utilize [(a noise level metric ‘and’ a signal level metric) ‘or’ a MOS metric]. More specifically, a threshold crossing event may comprise (a noise level above a particular level ‘and’ a signal level below a particular level) ‘or’ a MOS score below a particular level. It should be noted that any active metric can be combined with any other active metric(s) to create threshold crossing events. Thus, active unreported metrics can be combined with active detailed metrics and/or with always reported metrics. Furthermore, the metrics may be combined using any desirable logic, such as “and”, “or” or “not.”

Furthermore, a threshold crossing event may involve utilizing metric reports from multiple devices (e.g., endpoints and edgepoints) during a single call. Thus, MQMS 50 may base threshold crossing events on metrics used to detect end-to-end media quality, midpoint-to-endpoint media quality, and/or network specific (midpoint-to-midpoint) media quality. For example, manager 58 of MQMS 50 may combine metric reports from different edgepoints within a particular network. Differences between these metric reports may be used to trigger a threshold crossing event. More specifically, MQMS 50 may, for example, detect a threshold crossing event if the signal level drops more than a predetermined amount between any two edgepoints (i.e., the difference in signal level between the two edgepoints is greater than a predetermined amount). The threshold crossing event may be triggered even though the signal level at each edgepoint may itself not be low enough to trigger a threshold crossing event.

As mentioned above the threshold crossing event may trigger a change in when or if a particular metric is used in generating a metric report. For example, memory 56 may contain logic that may be used with the threshold crossing event to trigger sending a metric report. The metric report may be based on a detailed metric and may be generated on a periodic basis, at the end of a call, or when the threshold crossing event is detected. Similarly, logic stored within memory 56 may be used with the threshold crossing event to trigger a change in when a metric report is generated. For example, a metric report based on a detailed metric may be changed from being generated only at the end of the call to being generated when the threshold crossing event occurs and at the end of the call. Furthermore, it should be noted that the metric used in detecting the threshold crossing event and the metric used in generating the metric report may or may not be the same metric depending on the particular embodiment and/or configuration of manager 58. Accordingly, it may be that the metric report may not be of the detected threshold crossing event. For example, a signal level metric may be used detect a threshold crossing event, and in response MQMS 50 may generate a noise level metric report.

The threshold crossing event may also trigger changes within subsequent calls. In particular embodiments the threshold crossing action taken by MQMS 50 in response to a threshold crossing event in a call, such as the call between endpoints 72b and 72f, may be mirrored in a predetermined number of subsequent calls or in subsequent calls for a predetermined amount of time. Subsequent calls may include calls initiated, terminated or currently active after a threshold crossing event in which at least one of the endpoints involved in the call is an endpoint, such as endpoints 72a-72h, coupled to MQMS 50. In some embodiments, the action taken in subsequent calls, based on detecting a threshold crossing event in a previous call (e.g., the call between endpoints 72b and 72f), may be different than the action taken in the previous call. The threshold crossing action may be designed to improve the quality of the current or subsequent call or it may be designed to help troubleshoot the call or calls suffering from an impairment.

Particular embodiments may use snapshots of currently active metrics. The snapshots may continuously be taken, with the previous snapshot being saved or stored, for example within memory 56, until the next snapshot is ready. Thus, any time a threshold crossing event occurs, a snapshot may be available to be used in generating a metric report.

The threshold crossing event may also trigger consequent actions designed to improve the quality of the current call, for example the call between endpoints 72b and 72f, or to minimize or correct the impairment for subsequent calls facilitated by communication network 60. The consequent action may be performed on or by endpoints 72a-72h or it may be performed on or by various other components within communication network 60, such as an edgepoint, depending on what threshold crossing event was detected. Some of the consequent actions may include, for example, initiating a trace route, re-routing the call, changing the codec type, changing the frame size, changing the packetization period or performing any other desired action that may be implemented to improve the quality of the current or subsequent calls.

It will be recognized by those of ordinary skill in the art that MQMS 50 is merely one example configuration of a MQMS for adaptive media quality monitoring, in accordance with an embodiment of the present invention. Other MQMSs may include any number of interfaces, managers, processors, memory modules, and/or other components to accomplish the functionality and features described herein. For example, although MQMS 50 is illustrated and described as including interface 52, processor 54, memory module 56, and manager 58 these components and other desired components for performing the above described functionality may be centrally located (local) with respect to one another, or distributed throughout communication network 60.

FIG. 3 is a flowchart illustrating a method for adaptive media quality monitoring in accordance with an embodiment of the present invention. The method begins at step 300 where at least one metric is monitored for a call between two endpoints. The metric may be calculated to ascertain the quality of a call by measuring, detecting, rating, comparing and/or otherwise analyzing different aspects of the call. Depending on the configuration of the device monitoring the call, the device may use more than one metric. Some of the possible types of metrics that may be calculated and/or monitored include packet loss metrics, blockiness metrics, delay metrics, blurriness metrics, jerkiness metrics, jitter metrics, echo metrics, signal level metrics, frame freeze event metrics, frame skip event metrics, temporal complexity metrics, spatial complexity metrics, noise level metrics, mean opinion score metrics, concealed seconds metrics, and severely concealed seconds metrics. The various metrics may be monitored by endpoints, edgepoints, MQMSs, or any other component connected to communication network 60 that may be capable of monitoring calls. Depending on where the metric is monitored, the consequent action may be based on endpoint-to-endpoint media quality, endpoint-to-midpoint media quality, or midpoint-to-midpoint media quality.

These metrics may be used for any of a variety of purposes such as charting call quality performance and/or detecting threshold crossing events which may in turn trigger consequent actions. Should a particular aspect of a call being monitored by a specific metric fall below (rise above) a certain threshold with respect to one or more metrics, at step 310, a threshold crossing event may be detected. The threshold crossing event may be based on a single metric, a combination of metrics linked together with logic operators or differences in metric reports from different locations or components of the communication network(s).

The threshold crossing event may trigger any of a number of threshold crossing actions. The action taken may depend on the system, the threshold crossing event detected and/or the device that is monitoring the call. For example, if the device monitoring the call is a session border controller the threshold crossing action may involve changing the way calls are handled to avoid the call impairment in the future. If the device monitoring the call quality is an endpoint, such as an IP phone, the threshold crossing action may involve monitoring additional metrics to provide a more detailed diagnostic picture because the endpoint may have less control over the handling of the calls. The method depicted in FIG. 3 includes three possible threshold crossing actions at steps 320, 330 and 340. Other methods may include fewer or more threshold crossing actions. In addition, while a device may be capable of performing multiple threshold crossing actions, depending on the threshold crossing event, not all threshold crossing actions may be performed for each threshold crossing event. Furthermore, it should be noted that while steps 320 through 340 are listed sequentially, they may be performed simultaneously or in a different order depending on the threshold crossing event that was detected.

At step 320 additional metrics are monitored. The particular additional metrics monitored may depend on the threshold crossing event detected. For example, if a signal level metric detects a threshold crossing event the additional metric monitored may be a noise level metric. The additional metric may, like the original metric, be used to detect threshold crossing events on its own, or it may be used in combination with other metrics. One possible combination may be to combine the noise level metric with the signal level metric to detect a threshold crossing event indicating a call has a low signal level and a high noise level. Another possible combination may be to combine metrics from different edgepoints to determine medial quality of a particular network or domain.

In some embodiments detecting a threshold crossing event may not only trigger monitoring additional metrics for the call that experienced the threshold crossing event, as discussed with respect to step 320, but it may also trigger monitoring additional metrics in other calls either currently active or subsequently initiated. The additional metrics monitored in the other calls may be the same as the additional metric monitored at step 320 or it may be a different metric.

At step 330 a metric report is generated. As previously mentioned above, the monitored metrics may generally be classified as always reported, detailed and unreported. It may be noted that detecting a threshold crossing event may not trigger generating an always reported metric report because the always reported metric may already be used in generating metric reports for each call. However, the threshold crossing event may trigger a change to the timing of when the metric report based on the always reported metric is generated. For example, in some embodiments the MQMS, under normal conditions (no threshold crossing event detected), may generate a metric report for an always reported metric at the end of each call. When a threshold crossing event is detected the MQMS may, in addition to generating the metric report at the end of the call, generate the metric report upon detecting the threshold crossing event or it may continue to monitor the call for a predetermined amount of time before a metric report is generated. Each metric report that is generated may be based on both always reported metrics as well as any activated detailed metrics. The MQMS may also repeatedly generate the metric report based on updated information.

Similarly, in certain instances a detailed metric report may be generated depending on the embodiment, the detected threshold crossing event, and/or the metric. Some detailed metrics may not monitor a call (become active) until after a threshold crossing event has occurred, in which case it may be that the MQMS may wait a sufficient amount of time for the detailed metric to collect enough information before it generates a metric report. After waiting the sufficient amount of time the MQMS may generate the metric report, and may continue to do so at regular intervals for the duration of the call. The MQMS may also wait for the call to terminate and then generate the metric report (which may include information from the currently active metrics). Some embodiments may monitor detailed metrics for each call, but may only generate a metric report when a threshold crossing event is detected.

At step 340, the MQMS may initiate a consequent action. The consequent action may be any of a variety of different actions such as adjusting some aspect of the current call, adjusting some aspect of other calls, adjusting some aspect of the network facilitating the call, monitoring/activating additional metrics for other calls, generating reports for other calls, or initiating other diagnostic features for this call or other calls. The consequent action used may depend on the embodiment and/or the threshold crossing event that is detected.

For example, in some embodiments, in response to a threshold crossing event the MQMS may initiate a trace route to determine the routing of packets for the call. In particular embodiments the consequent action may include changing the codec type, frame size, or packetization period. These changes may apply to the current call (the call the experienced the threshold crossing event) as well as to other calls either currently or subsequently initiated.

It should be noted that depending on the embodiment, the consequent action may be applied to subsequent calls initiated within a certain amount of time, or it may be applied to a specific number of calls.

Some of the steps illustrated in FIG. 3 may be combined, modified or deleted where appropriate, and additional steps may also be added to the flowchart. Additionally, steps may be performed in any suitable order without departing from the scope of the invention.

As indicated above, technical advantages of particular embodiments include methods and systems that enable a MQMS to adapt its call quality monitoring in response to detected impairments. Thus resources are not wasted generating, transmitting and/or storing metric reports that may be of little to no diagnostic use. However, the MQMS still allows for more detailed information to be provided via metric reports by causing additional metric reports to be generated upon detecting an impairment within a call. The metric reports generated by the threshold crossing event may be of little to no value when the call is of acceptable quality but may be of great value in trouble shooting a call that has experienced an impairment.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 30 and MQMS 50, these elements may be combined, rearranged or positioned in order to accommodate particular routing architectures or needs. In addition, any of these elements may be provided as separate external components to communication system 30, MQMS 50 or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for adaptive media quality monitoring, comprising:
monitoring at least one metric of a call between at least two endpoints;
detecting a threshold crossing event via the monitoring of the at least one metric;
executing a threshold crossing action based on detecting the threshold crossing event; and
the threshold crossing action comprising monitoring at least one additional metric of the call.

2. The method of claim 1, wherein the threshold crossing action further comprises generating a metric report upon detecting a threshold crossing event via the monitoring of the at least one metric.

3. The method of claim 1, wherein the threshold crossing action further comprises initiating at least one consequent action from the group consisting of initiating a trace route, re-routing the call, changing a codec type, changing a frame size, and changing a packetization period.

4. The method of claim 1, wherein:
monitoring at least one metric of a call comprises monitoring a plurality of metrics of the call; and
detecting a threshold crossing event via the monitoring of the at least one metric comprises:
evaluating the plurality of metrics; and
detecting a threshold crossing event based on the evaluation of the plurality of metrics.

5. The method of claim 1, wherein the threshold crossing action further comprises generating periodic reports of the monitored at least one metric during the call.

6. The method of claim 1, wherein the threshold crossing action further comprises generating periodic reports of the monitored at least one additional metric during the call.

7. The method of claim 1, wherein monitoring at least one metric of a call between at least two endpoints comprises monitoring at least one metric of the call at one of the at least two endpoints.

8. The method of claim 1, wherein monitoring at least one metric of a call between at least two endpoints comprises monitoring at least one metric of the call at an intermediary component between the at least two endpoints.

9. The method of claim 8, wherein the intermediary component between the at least two endpoints comprises an edgepoint.

10. The method of claim 1, wherein the at least one metric comprises at least one metric selected from the group consisting of packet loss metric, blockiness metric, delay metric, blurriness metric, jerkiness metric, jitter metric, echo metric, signal level metric, frame freeze event metric, frame skip event metric, temporal complexity metric, spatial complexity metric, noise level metric, mean opinion score metric, concealed seconds metric, and severely concealed seconds metric.

11. The method of claim 1, wherein the threshold crossing action further comprises monitoring the at least one additional metric of the call for a predetermined amount of time during the call.

12. The method of claim 1, wherein the threshold crossing action further comprises monitoring the at least one additional metric for subsequent calls for a first amount of time.

13. A system for adaptive media quality monitoring, comprising:
an interface operable to monitor at least one metric of a call between at least two endpoints;
a processor coupled to the interface and operable to:
detect a threshold crossing event via the interface operable to monitor the at least one metric; and
execute a threshold crossing action based on detecting the threshold crossing event; and
the threshold crossing action comprising monitoring at least one additional metric of the call.

14. The system of claim 13, wherein the threshold crossing action further comprises generating a metric report upon detecting a threshold crossing event via the monitoring of the at least one metric.

15. The system of claim 13, wherein the threshold crossing action further comprises initiating at least one consequent action from the group consisting of initiating a trace route, re-routing the call, changing a codec type, changing a frame size, and changing a packetization period.

16. The system of claim 13, wherein:
the interface operable to monitor at least one metric of a call comprises an interface operable to monitor a plurality of metrics of the call; and
the processor operable to detect a threshold crossing event via the interface operable to monitor the at least one metric comprises a processor operable to:
evaluate the plurality of metrics; and
detect a threshold crossing event based on the evaluation of the plurality of metrics.

17. The system of claim 13, wherein the threshold crossing action further comprises generating periodic reports of the monitored at least one metric during the call.

18. The system of claim 13, wherein the threshold crossing action further comprises generating periodic reports of the monitored at least one additional metric during the call.

19. The system of claim 13, wherein the interface operable to monitor at least one metric of a call between at least two endpoints comprises an interface operable to monitor at least one metric of the call at one of the at least two endpoints.

20. The system of claim 13, wherein the interface operable to monitor at least one metric of a call between at least two endpoints comprises an interface operable to monitor at least one metric of the call at an intermediary component between the at least two endpoints.

21. The method of claim 20, wherein the intermediary component between the at least two endpoints comprises an edgepoint.

22. The system of claim 13, wherein the at least one metric comprises at least one metric selected from the group consisting of packet loss metric, blockiness metric, delay metric, blurriness metric, jerkiness metric, jitter metric, echo metric, signal level metric, frame freeze event metric, frame skip event metric, temporal complexity metric, spatial complexity metric, noise level metric, mean opinion score metric, concealed seconds metric, and severely concealed seconds metric.

23. The system of claim 13, wherein the threshold crossing action further comprises monitoring the at least one additional metric of the call for a predetermined amount of time during the call.

24. The system of claim 13, wherein the threshold crossing action further comprises monitoring the at least one additional metric for subsequent calls for a first amount of time.

25. Logic embodied in a computer readable medium, the computer readable medium comprising code operable to:
monitor at least one metric of a call between at least two endpoints;
detect a threshold crossing event via the code operable to monitor the at least one metric;
execute a threshold crossing action based on the code operable to detect the threshold crossing event; and
the threshold crossing action comprising monitoring at least one additional metric of the call.

26. The medium of claim 25, wherein the threshold crossing action further comprises generating a metric report upon detecting a threshold crossing event.

27. The medium of claim 25, wherein the threshold crossing action further comprises initiating at least one consequent action from the group consisting of initiating a trace route, re-routing the call, changing a codec type, changing a frame size, and changing a packetization period.

28. The medium of claim 25, wherein:
the code operable to monitor at least one metric of a call comprises code operable to monitor a plurality of metrics of the call; and
the code operable to detect a threshold crossing event comprises code operable to:
evaluate the plurality of metrics; and
detect a threshold crossing event based on the evaluation of the plurality of metrics.

29. The medium of claim 25, wherein the threshold crossing action further comprises generating periodic reports of the monitored at least one metric during the call.

30. The medium of claim 25, wherein the threshold crossing action further comprises generating periodic reports of the monitored at least one additional metric during the call.

31. The medium of claim 25, wherein the code operable to monitor at least one metric of a call between at least two endpoints comprises code operable to monitor at least one metric of the call at one of the at least two endpoints.

32. The medium of claim 25, wherein the code operable to monitor at least one metric of a call between at least two endpoints comprises code operable to monitor at least one metric of the call at an intermediary component between the at least two endpoints.

33. The method of claim 32, wherein the intermediary component between the at least two endpoints comprises an edgepoint.

34. The medium of claim 25, wherein the at least one metric comprises at least one metric selected from the group consisting of packet loss metric, blockiness metric, delay metric, blurriness metric, jerkiness metric, jitter metric, echo metric, signal level metric, frame freeze event metric, frame skip event metric, temporal complexity metric, spatial complexity metric, noise level metric, mean opinion score metric, concealed seconds metric, and severely concealed seconds metric.

35. The medium of claim 25, wherein the threshold crossing action further comprises monitoring the at least one additional metric of the call for a predetermined amount of time during the call.

36. The medium of claim 25, wherein the threshold crossing action further comprises monitoring the at least one additional metric for subsequent calls for a first amount of time.

37. A system for adaptive media quality monitoring, comprising:
means for monitoring at least one metric of a call between at least two endpoints;
means for detecting a threshold crossing event via the monitoring of the at least one metric;
means for executing a threshold crossing action based on detecting the threshold crossing event; and
the threshold crossing action comprising monitoring at least one additional metric of the call.
